(19) United States
(12) Patent Application Publication
(10) Pub. No.: US 2004/0207102 A1
(43) Pub. Date: Oct. 21, 2004

(54) Method of cooling high-temperature exhaust gas, apparatus therefor and combustion treatment equipment

(76) Inventors: Yoshiaki Sugimori, Tokyo (JP); Takashi Kojima, Miyazaki (JP); Shuichi Koseki, Tokyo (JP); Hirotaka Mangyou, Tokyo (JP); Nobuyasu Tomita, Tokyo (JP); Hiroyuki Ono, Tokyo (JP); Hiroshi Shirase, Chiba (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/486,191

(22) PCT Filed: Aug. 15, 2002
(86) PCT No.: PCT/JP02/08286

(30) Foreign Application Priority Data
Aug. 17, 2001 (JP) 2001-247880

(51) Int. Cl. B01F 3/04

(52) U.S. Cl. 261/112.1; 261/118

(57) ABSTRACT

Provided are a method and an apparatus for cooling a high-temperature exhaust gas, capable of cooling effectively the high-temperature exhaust gas with a small amount of water, as well as, a combustion treatment equipment provided with the cooling apparatus. According to this method, a water curtain is formed orthogonal to the flow of the exhaust gas within a passage through which the high-temperature exhaust gas flows, and the high-temperature exhaust gas is allowed to pass through the water curtain to be cooled thereby. The cooling apparatus is provided with cylindrical cooling chamber (53) having at an upper position a high-temperature exhaust gas inlet (51) and at a lower position a cooled exhaust gas outlet (52); and a plurality of water spray pipes (54) arranged near the high-temperature exhaust gas inlet. Spray nozzles (58) of the water spray pipes (54) are arranged such that spouting axes of the nozzles (58) direct toward the center of the cooling chamber (53) substantially on the same horizontal plane and that water droplets spouted through the respective spray nozzles impinge against one another.

### TECHNICAL FIELD

The present invention relates to a method of cooling a high-temperature exhaust gas, an apparatus therefor and a combustion treatment equipment, more specifically to a method of cooling high-temperature exhaust gases to be formed by carrying out various kinds of combustion treatments, an apparatus therefor, as well as, a combustion treatment equipment provided with such a cooling apparatus.

### BACKGROUND ART

High-temperature exhaust gases are generated by iron making, incineration of scourings, combustion treatment of toxic components and so on. It is prohibited under antipollution regulation to release such high-temperature exhaust gases as such into the atmosphere. Thus, exhaust gases are cooled before they are exhausted.

FIG. 7 is a vertical cross-sectional view showing an example of conventional exhaust gas cooling apparatus. A high-temperature exhaust gas is introduced into a cooling chamber 12 constituting a cooling apparatus 11 through an inlet 13 located at the top of the cooling chamber and then exhausted through an exhaust port 14 formed in a peripheral wall of the cooling chamber at a lower position. In this process, the high-temperature exhaust gas introduced into the cooling chamber is brought into contact with water spouted through a spray nozzle 16 of a spray pipe 15 provided at an upper position of the cooling chamber 12 and is cooled thereby. Solid contents and water drops contained in the cooled exhaust gas exhausted through the exhaust port 14 are captured by a filler 18 provided in a demister 17. The demister 17 is provided with a water-spouting spray 19 for cleaning the filler 18.

In this cooling apparatus 11, water is designed to be spouted through the spray nozzle 16 in the same direction as the flow direction of the exhaust gas so that the water does not induce resistance against the flow of the gas. The water spouted through the spray nozzle 16 and cooled the exhaust gas is discharged through a drain port 20 provided at the bottom of the cooling chamber 12. The drain port 20 is connected to a drain pipe 21, which is provided with a trap 22 bent upward so as to prevent the exhaust gas from flowing out through the drain pipe 21. Meanwhile, the downstream end of the drain pipe 21 is submerged in water collected in a water tank 23 to prevent the atmospheric air from flowing upstream into the cooling chamber 12 through the drain pipe 21.

However, the conventional cooling apparatus as described above requires a large amount of water for cooling a high-temperature exhaust gas and also a large cooling chamber for bringing the exhaust gas fully into contact with water. Further, it is necessary to install, in addition to the cooling chamber, a demister for removing solid contents and water drops from the exhaust gas and to employ a draining structure which leads no gas therethrough. Thus, the cooling apparatus as a whole comes to have an increased size.

Under such circumstances, the present invention is directed to providing a cooling method and a cooling apparatus, capable of achieving not only effective cooling of a high-temperature exhaust gas with a small amount of water but also downsizing of the apparatus, as well as, a combustion treatment equipment integrated with the cooling apparatus.

### DISCLOSURE OF THE INVENTION

In order to attain the above object, the method of cooling a high-temperature exhaust gas according to the present invention is directed to passing high-temperature exhaust gas through a water curtain formed within a passage of the high-temperature exhaust gas orthogonal to a flow direction thereof.

The apparatus for cooling a high-temperature exhaust gas according to the present invention comprises a hollow cooling chamber having at an upper position a high-temperature exhaust gas inlet, and at lower positions a cooled exhaust gas outlet and a draining section, and a plurality of water spray pipes arranged near the high-temperature exhaust gas inlet; wherein spray nozzles of the water spray pipes are arranged on the same horizontal plane such that water is spouted through each spray nozzle orthogonal to a flow direction of the high-temperature exhaust gas flowing into the cooling chamber through the high-temperature exhaust gas inlet and that water droplets spouted through the respective spray nozzles impinge against one another.

The cooled exhaust gas outlet is preferably an exhaust pipe protruding inward from the peripheral wall of the cooling chamber at a lower position. Further, it is preferred that the spray nozzles be arranged such that their axes each form an angle of 5 to 15° in the same direction with respect to lines passing through the center of the cooling chamber and tips of the respective nozzles on the same horizontal plane. Moreover, the cooling chamber preferably has a double wall structure consisting of an internal cylinder and an outer casing, with an upper opening of the internal cylinder communicating with the high-temperature exhaust gas inlet through a spray nozzle section, whereas a lower opening of the internal cylinder being located adjacent to an upper surface of a bottom plate of the outer casing; the outer casing has a cooled exhaust gas outlet formed at an upper position thereof; a demister is provided between the cooled exhaust gas outlet and the lower opening of the internal cylinder to extend from an outer circumference of the internal cylinder to an inner circumference of the outer casing. The draining section is provided with a drain chamber having a drain port opening to a lower part of the cooling chamber to communicate therewith and a drain pipe connected such that it opens at a position higher than the drain port.

The combustion treatment equipment according to the present invention comprises a structure in which a combustion chamber provided with a burner capable of forming a horizontal flame is located above the high-temperature exhaust gas cooling apparatus.

According to the present invention, water droplets spouted through the spray nozzle are designed to impinge upon one another to be divided into finer droplets and form a water curtain through which a high-temperature exhaust gas is allowed to pass, so that the gas-liquid contact efficiency is improved to improve the efficiency of cooling the high-temperature exhaust gas, achieving a cooling performance comparable to that of the conventional cooling apparatus by using a smaller amount of water. In addition, the present invention can achieve downsizing of the entire apparatus.

### BRIEF DESCRIPTION OF THE DRAWINGS

FIG. 1 is a vertical cross-sectional view showing a cooling apparatus according to a first embodiment of the present invention;

FIG. 2 is a vertical cross-sectional view showing a cooling apparatus according to a second embodiment of the present invention;

FIG. 3 is a horizontal cross-sectional view of the cooling chamber showing an example of spray nozzle arrangement;

FIG. 4 is a vertical cross-sectional view showing a cooling apparatus according to a third embodiment of the present invention;

FIG. 5 is a vertical cross-sectional view showing a combustion treatment equipment according to one embodiment of the present invention;

FIG. 6 is a vertical cross-sectional view showing a pertinent section of the burner; and

FIG. 7 is a vertical cross-sectional view showing an example of conventional gas cooling apparatus.

### BEST MODE FOR CARRYING OUT THE INVENTION

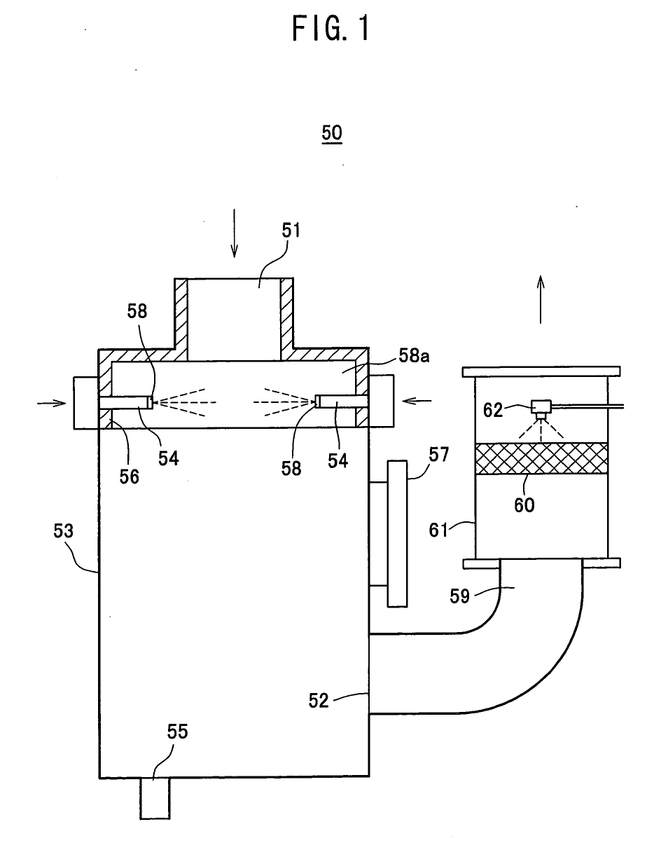

FIG. 1 is a vertical cross-sectional view showing a cooling apparatus according to a first embodiment of the present invention for carrying out the method of cooling a high-temperature exhaust gas.

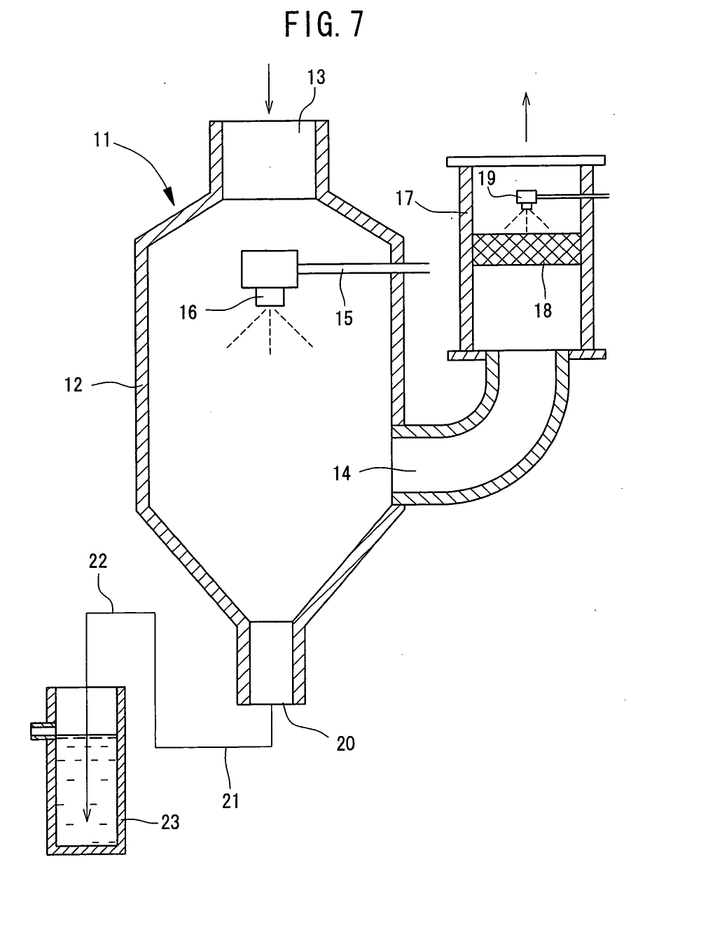

The cooling apparatus 50 is provided with a cylindrical cooling chamber 53, having a high-temperature exhaust gas inlet 51 at an upper position and a cooled exhaust gas outlet 52 at a lower position of a peripheral wall; a plurality of water spray pipes 54 arranged near the high-temperature exhaust gas inlet 51; and a draining section 55 located in the bottom of the cooling chamber 53. To this draining section 55 is connected a drain pipe provided with a trap bent upward to prevent the exhaust gas from flowing out through the drain pipe, like in the prior art example shown in FIG. 7. Meanwhile, the downstream end of the drain pipe is submerged in water to prevent the atmospheric air from flowing upstream into the cooling chamber through the drain pipe. A lining 56 of a heat-resistant material is applied to the upper inner circumference of the cooling chamber 53. Further, the cooling chamber 53 has an inspection window defined in the peripheral wall thereof.

A plurality of spray nozzles 58 are attached to the water spray pipes 54 respectively. The spray nozzles 58 are arranged such that the spouting axes thereof direct toward the center of the cooling chamber 53 substantially on the same horizontal plane and that water droplets spouted through the spray nozzles 58 impinge upon one another. Further, there are used as the spray nozzles 58 fan-shaped nozzles each spouting out water horizontally in a fan shape.

A water curtain is formed within the cooling chamber 53 orthogonal to the flow direction of the high-temperature exhaust gas, by arranging the spray nozzles 58 at the spray nozzle section 58a as described above, as if the water curtain totally seals off the gas flow passage. Besides, the substantial part of the water droplets spouted through the spray nozzles 58 impinge upon one another to form finer droplets.

The number of water spray pipes 54 to be provided can be selected as desired, and at least three water spray pipes can be provided depending on the size of the cooling chamber 53, the temperature of the high-temperature exhaust gas and the flow rate thereof. While each water spray pipe 54 may have one spray nozzle 58, the water spray pipes 54 may each have a plurality of spray nozzles 58. Further, the plurality of spray nozzles 58 are preferably arranged at equal intervals.

An exhaust pipe 59 is connected to the cooled exhaust gas outlet 52 and is provided with a demister 61 containing a filler 60. A cooled exhaust gas suction blower (not shown) is provided on the downstream side of the demister 61. Solid contents and water droplets contained in the cooled exhaust gas exhausted through the cooled exhaust gas outlet 52 are captured by the filler 60 when they pass through the demister 61. The filler 60 is cleaned periodically by water spouted through a spray 62.

In the thus constituted cooling apparatus 50, a high-temperature exhaust gas introduced through the high-temperature exhaust gas inlet 51 into the cooling chamber 53 is cooled with the water curtain formed by the water spouted through the spray nozzles 58. Since the water droplets having formed the water curtain drop by their own weights within the chamber, they do not induce resistance against the flow of the high-temperature exhaust gas. Further, the water droplets divided into finer droplets through impingement with one another undergo evaporation as soon as they are brought into contact with the high-temperature exhaust gas, so that the latent heat of vaporization of water can be utilized effectively for cooling of the high-temperature exhaust gas.

Thus, the above cooling apparatus can ensure contact between a high-temperature exhaust gas and water and also can effectively utilize the latent heat of vaporization of water to give improved cooling efficiency, to reduce the amount of water to be used by a wide margin over the prior art cooling apparatuses for achieving a comparable level of cooling and to contribute to downsizing of the apparatus.

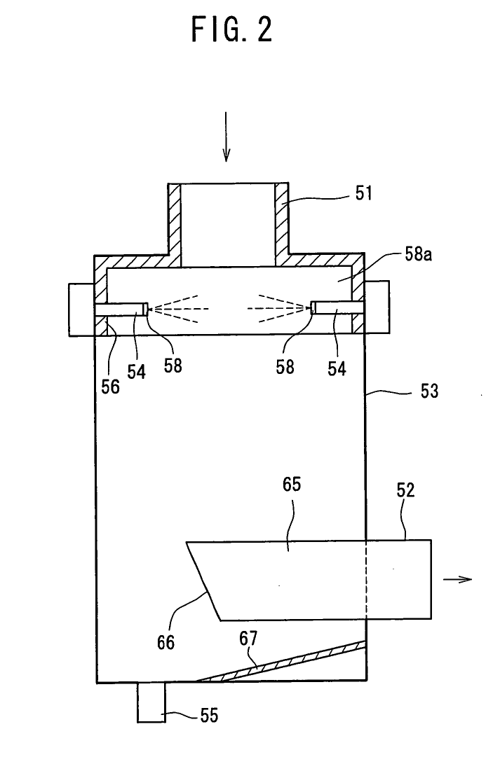

FIG. 2 is a vertical cross-sectional view showing a cooling apparatus according to a second embodiment of the present invention. It should be noted here that in the following description the same or like components as those in the cooling apparatus of the first embodiment are affixed with the same reference numbers respectively, and detailed descriptions of them will be omitted.

In this embodiment, the cooled exhaust gas outlet 52 is provided with an exhaust pipe 65 protruding horizontally inward from a lower part of the peripheral wall of the cooling chamber 53 so that a gas suction port 66 of the exhaust pipe 65 opens to the center of the cooling chamber 53. This constitution achieves uniformalization of the exhaust gas flow, so that the overall cooling effect can further be improved. In addition, in this embodiment, a sloping plate 67 is provided in the bottom of the cooling chamber 53 so as to form no dwelling gas.

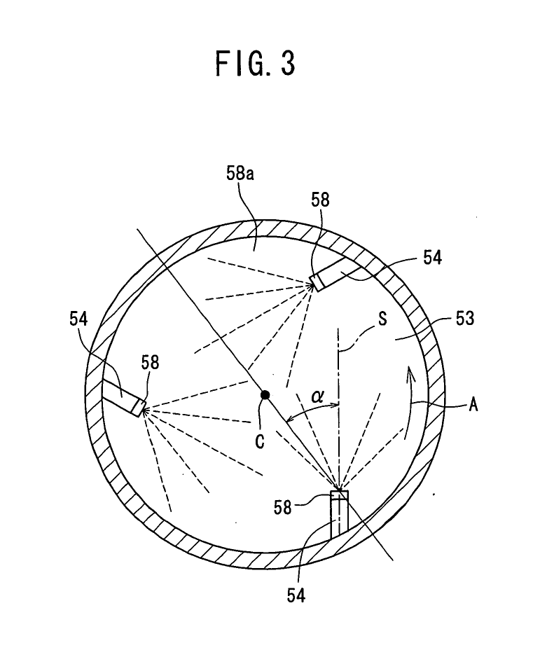

FIG. 3 is a horizontal cross-sectional view of the cooling chamber showing an example of spray nozzle arrangement. In this embodiment, three spray nozzles 58 are arranged at 120° intervals such that the spouting axes S of the spray nozzles 58 each form an angle α in the same direction with respect to lines passing the center C of the cooling chamber 53 and the tips of the respective nozzles 58. The water spouted through each spray nozzle 58 is caused to swirl counterclockwise within the cooling chamber 53 as indicated by the arrow A in FIG. 3 by tilting the spouting axes S of the spray nozzles 58 in the same direction with respect to the lines passing the center C of the cooling chamber and the tips of the respective spray nozzles, as described above, to form a swirling water curtain having a face orthogonal to the flow direction of the high-temperature exhaust gas in the cooling chamber 53. The thus formed swirling water curtain causes the high-temperature exhaust gas to swirl under the influence of the swirling motion of the water curtain applied when the gas passes through the water curtain and generates a stirring effect, enhancing further the cooling effect.

While the angle α can be selected suitably depending on the state of the cooling chamber 53, the state of the high-temperature exhaust gas and the number of spray nozzles arranged, it is generally within the range of 5 to 15°. If the angle α is smaller than 5°, sufficient swirling force cannot be applied to the water curtain; whereas if the angle α is greater than 15°, it becomes difficult to totally seal off the gas flow passage unless a larger number of spray nozzles 58 are arranged to be likely to increase the amount of water needed.

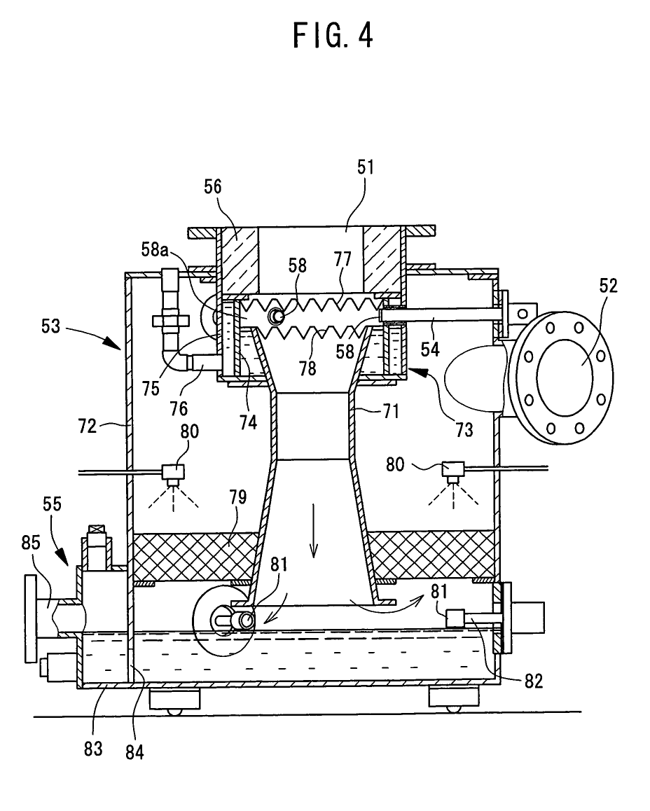

FIG. 4 is a vertical cross-sectional view showing the cooling apparatus according to a third embodiment of the present invention. In this cooling apparatus, the cooling chamber 53 is designed to have a double wall structure consisting of an internal cylinder 71 with an upper opening and a lower opening and an outer casing 72 located to surround the internal cylinder 71. The outer casing 72 has a closed upper end and a closed lower end. The upper opening of the internal cylinder 71 communicates with the high-temperature exhaust gas inlet 51 through the spray nozzle section, thereby a water curtain is formed with the aid of the spray nozzles 58 between the upper opening of the internal cylinder 71 and the high-temperature exhaust gas inlet 51. Further, the upper part of the internal cylinder 71 is surrounded with a water tank 73 having a double wall structure, and the water spray nozzles 54 are provided to penetrate through an inner peripheral wall 74 and an outer peripheral wall 75 of the water tank 73. The water tank 73 is provided with a pipe 76 for supplying a coolant into the space defined between the inner peripheral wall 74 and the outer peripheral wall 75. The coolant supplied to between the walls 74 and 75 flows over through V notches 77 formed along the upper edge of the inner peripheral wall 74 into the space defined between the wall 74 and the upper part of the internal cylinder 71 and flows further into the internal cylinder 71 over through V notches 78 formed along the upper edge thereof.

The internal cylinder 71 shown in this embodiment is reduced at the middle part so as to increase the gas flow rate at the reduced portion, improving the efficiency of contact between the gas and the water droplets to enhance the effect of cooling a high-temperature exhaust gas. Incidentally, the internal cylinder 71 may be a straight pipe.

The lower opening of the internal cylinder 71 is located near the upper surface of the bottom plate of the outer casing 72, and the outer casing 72 has the cooled exhaust gas outlet 52 formed at an upper position of the peripheral wall. A filler constituting a demister 79 is provided between the cooled exhaust gas outlet 52 and the lower opening of the internal cylinder 71 to extend from the outer circumference of the internal cylinder 71 to the inner circumference of the outer casing 72.

Thus, the high-temperature exhaust gas introduced through the high-temperature exhaust gas inlet 51 into the cooling chamber 53 cuts across the water curtain formed with the aid of the spray nozzles 58 to flow down within the internal cylinder 71 being in contact with water droplets to be cooled therewith. Then, the gas flows out through the lower opening of the internal cylinder 71 into the outer casing 72 to flow up the space defined between the outer circumference of the internal cylinder 71 and the inner circumference of the outer casing 72, while the solid contents and water droplets contained in the gas are removed when the gas passes through the demister 79, and then the gas is exhausted through the cooled exhaust gas outlet 52. Therefore, the demister to be attached to the exhaust pipe can be omitted, and the exhaust piping space can be reduced. The filler polluted with the solid contents adsorbed thereby can be cleaned with the water spouted through sprays 80 located above the filler.

Further, in this embodiment, water spray pipes 82 each having a spray nozzle 81 at the tip are provided to penetrate through the peripheral wall of the outer casing 72 at lower positions. These spray nozzles 81 likewise form a water curtain below the internal cylinder 71 to cool further the gas flowing out through the lower opening of the internal cylinder 71.

The draining section 55 has a drain chamber 83 formed integrally with the outer casing 72. This drain chamber 83 is provided with a drain port 84 opening to a lower part of the cooling chamber 53 to communicate therewith and a drain pipe 85 connected such that it opens at a position higher than the upper edge of the drain port 84. Referring to the position of the lower edge of the opening of this draining pipe 85, it is designed to locate lower than the spray nozzles 81 provided that the apparatus has the spray nozzles 81. In the case where the apparatus has no spray nozzles 81, the lower edge of the opening of the draining pipe 85 may be located lower than the lower opening of the internal cylinder 71.

The water flowed down to the bottom of the cooling chamber 53 flows further through the drain port 84 into the drain chamber 83 and is discharged through the drain pipe 85. Here, since the drain pipe 85 is located at a position higher than the drain port 84, water accumulates in the bottom of the cooling chamber up to the level of the drain pipe 85 to seal off the drain port 84 therewith. The drain port 84 thus sealed off with water can prevent passage of the gas through the drain port 84, preventing the exhaust gas from leaking through the draining section 55 and also the atmospheric air from flowing into the cooling chamber 53. This dispenses with the trap to be attached to the drain pipe 85 in its pathway, so that drain piping space can be reduced.

The entire cooling apparatus can be downsized by allowing the cooling chamber 53 to have a double wall structure and containing the demister 79 in this structure and by forming the drain chamber 83 having a trapping function integrally with the cooling chamber 53 as described above. Incidentally, the exhaust pipe and the drain pipe may, as necessary, be provided with the demisters or traps like in the conventional cooling apparatus.

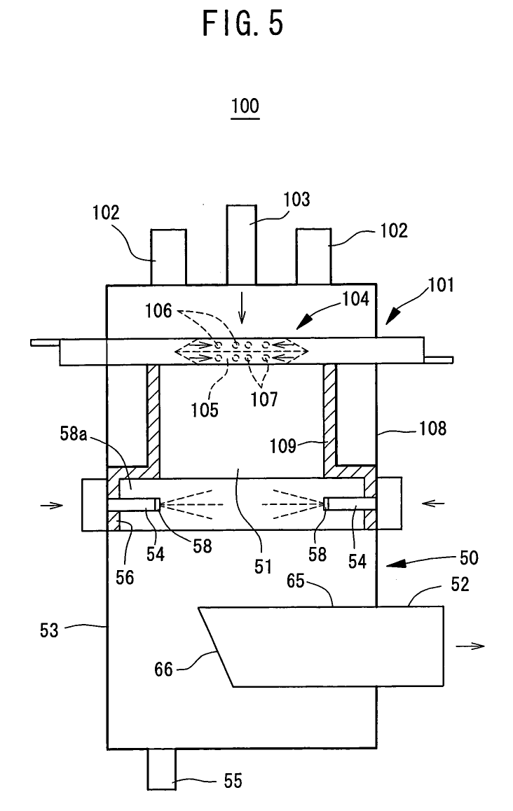

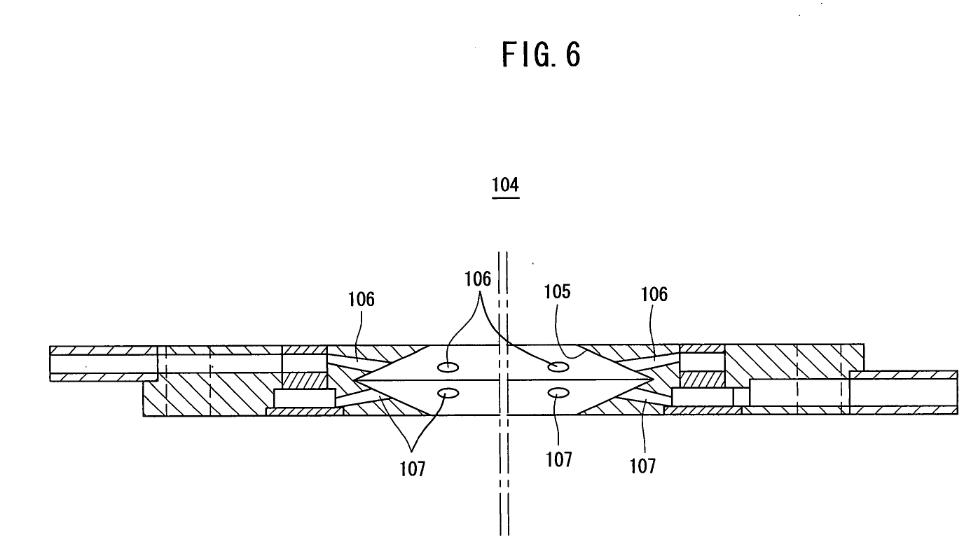

FIG. 5 is a vertical cross-sectional view showing a combustion treatment equipment according to one embodiment of the present invention; and FIG. 6 is a vertical cross-sectional view showing a pertinent section of the burner. In the combustion treatment equipment, a high-temperature exhaust gas cooling apparatus having the constitution as described above is integrated into a combustion treatment equipment for carrying out various kinds of combustion treatments, e.g., detoxication treatment of a gas containing toxic components.

The combustion treatment equipment 100 has a combustion chamber 101 located above the cooling chamber 53 of the cooling apparatus having the constitution as described above and carries out combustion treatments. The combustion chamber 101 is directly connected at the lower end thereof to the high-temperature exhaust gas inlet 51 located at the upper end of the cooling chamber 53.

The combustion chamber 101 is provided at the top with gas introducing pipes 102, through which a gas to be subjected to combustion treatment is introduced and a pilot burner 103; and a burner 104, which forms a flat flame, located below them. The burner 104 has a V-channel nozzle 105 formed on the annular internal side thereof. The V-channel nozzle 105 has fuel passages 106 formed on one side and combustion assisting gas passages 107 formed on the other side. The fuel passages 106 supply a fuel such as LPG, while the combustion assisting gas passages 107 supply a gas which increases susceptibility of the fuel to burn, such as air and an oxygen enriched air. The fuel passages 106 and the combustion assisting gas passages 107 are arranged along the inner circumference of the V-channel nozzle 105, and the fuel passages 106 and the combustion assisting gas passages 107 blow out the fuel and the combustion assisting gas respectively. In this state, the fuel is ignited with the pilot burner 103 to form a flat flame orthogonal to the flow direction of the gas to be subjected to the combustion treatment.

Here, as the burner for forming a flat flame, the structure as described in Japanese Unexamined Patent Publication No. 2001-82733 is most suitably used. The structure of the combustion chamber as described in the Publication is also applied most suitably to the combustion chamber 101. However, the structure of the burner and that of the combustion chamber are not to be limited to them, but suitable structures can be employed respectively depending on the subject to be subjected to the combustion treatment, the amount thereof, etc. For example, the fuel and the combustion assisting gas may be mixed with each other within the burner before they are spouted through it.

Meanwhile, the combustion chamber 101 has a double wall structure consisting of a metallic outer casing 108 and a sintered metal internal cylinder 109. The internal cylinder 109 is combined at the lower end thereof with the high-temperature exhaust gas inlet 51. Thus, a high-temperature exhaust gas generated by combustion within the combustion chamber 101 flows into the cooling chamber 53 through the lower part of the internal cylinder 109 and passes through a water curtain formed with water spouted through the spray nozzles 58 arranged within the cooling chamber 53 as described above to be cooled therewith, and then the thus cooled exhaust gas is sucked by a blower (not shown) to be exhausted through the cooled exhaust gas outlet 52.

In this combustion treatment equipment 100, the gas to be subjected to combustion treatment introduced through the gas introducing pipes 102 into the combustion chamber 101 is subjected to predetermined combustion treatment when it passes through the flat flame formed with the aid of the burner 104, and a high-temperature exhaust gas generated here is introduced directly into the cooling apparatus 50 and is cooled therein. As described above, the combustion treatment equipment has a combination of the combustion chamber 101 provided with a burner 104 capable of forming a flat flame orthogonal to the flow direction of the gas to be subjected to the combustion treatment and a cooling apparatus 50 capable of forming a water curtain orthogonal to the flow direction of the high-temperature exhaust gas, in which the flat flame and the flat water curtain can be located adjacent to each other, so that the size of the equipment in the gas flow direction can be reduced, contributing to downsizing of the entire equipment.

### EXAMPLE

A detoxication treatment of a gas to be subjected to combustion treatment was carried out using a combustion chamber having the structure as shown in FIG. 5 by introducing as the subject gas a nitrogen gas containing 3% of silane (SiH₄) as a harmful gas into the combustion chamber through the gas introducing pipes at a rate of 200 L/min and by passing the gas through a flat flame formed with the aid of the burner using LPG as a fuel and air as a combustion assisting gas to effect combustion of silane. In this combustion treatment, a high-temperature exhaust gas of ca. 1000° C. was generated in the combustion chamber at a rate of 800 L/min.

Then, the high-temperature exhaust gas was cooled with water supplied at a rate of 5 L/min using the cooling apparatus of the first embodiment having the spray nozzles 54 arranged such that the spouting axes thereof direct toward the center of the cooling chamber, and the gas exhausted through the cooled exhaust gas outlet had a temperature of 73° C. Meanwhile, when the high-temperature exhaust gas was cooled with water by introducing it to the conventional cooling apparatus shown in FIG. 7, it required at least 20 L/min of water to achieve cooling of the high-temperature exhaust gas to 73° C.

Next, cooling of the high-temperature exhaust gas was carried out under the same conditions except that there was used a cooling apparatus having the structure of the second embodiment provided with the cooled exhaust gas outlet protruding into the cooling chamber. Thus, the gas exhausted through the cooled exhaust gas outlet had a temperature of 71° C. The result shows that the cooling efficiency can be increased by the cooled exhaust gas outlet protruding into the cooling chamber.

Further, cooling of the high-temperature exhaust gas was carried out under the same conditions using the cooling apparatus of the second embodiment except that the spouting axes of the spray nozzles were tilted by 10° with respect to the lines passing the center of the cooling chamber and the tips of the respective spray nozzles, as shown in FIG. 3, to form a swirling water curtain. As a result, the gas exhausted through the cooled exhaust gas outlet had a temperature of 69.5° C. This shows that the cooling efficiency can further be improved by swirling the water curtain.

1. A method of cooling a high-temperature exhaust gas, which comprises allowing the high-temperature exhaust gas to pass through a water curtain formed within a passage of the high-temperature exhaust gas orthogonal to a flow direction thereof.

2. An apparatus for cooling a high-temperature exhaust gas, comprising:
a hollow cooling chamber having at an upper position a high-temperature exhaust gas inlet, and at lower positions a cooled exhaust gas outlet and a draining section; and
a plurality of water spray pipes arranged near the high-temperature exhaust gas inlet;
wherein spray nozzles of the water spray pipes are arranged on the same horizontal plane such that water is spouted through each spray nozzle orthogonal to a flow direction of the high-temperature exhaust gas flowing into the cooling chamber through the high-temperature exhaust gas inlet and that water droplets spouted through the respective spray nozzles impinge against one another.

3. The apparatus for cooling a high-temperature exhaust gas according to claim 2, wherein the cooled exhaust gas outlet is an exhaust pipe protruding inward from the peripheral wall of the cooling chamber at a lower position.

4. The apparatus for cooling a high-temperature exhaust gas according to claim 2 or 3, wherein the spray nozzles are arranged such that spouting axes thereof each form an angle of 5 to 15° in the same direction with respect to lines passing through the center of the cooling chamber and tips of the respective nozzles on the same horizontal plane.

5. The apparatus for cooling a high-temperature exhaust gas according to claim 2 or 3, wherein the cooling chamber has a double wall structure comprising an internal cylinder and an outer casing, with an upper opening of the internal cylinder communicating with the high-temperature exhaust gas inlet through a spray nozzle section, whereas a lower opening of the internal cylinder being located adjacent to an upper surface of a bottom plate of the outer casing; the outer casing having a cooled exhaust gas outlet formed at an upper position thereof; a demister being provided between the cooled exhaust gas outlet and the lower opening of the internal cylinder to extend from an outer circumference of the internal cylinder to an inner circumference of the outer casing.

6. The apparatus for cooling a high-temperature exhaust gas according to claim 2 or 3, wherein the draining section is provided with a drain chamber having a drain port opening to a lower part of the cooling chamber to communicate therewith and a drain pipe connected such that it opens at a position higher than the drain port.

7. A combustion treatment equipment, comprising a burner capable of forming a horizontal flame, located above the high-temperature exhaust gas cooling apparatus as set forth in claim 2.
